(19) United States
(12) Patent Application Publication
(10) Pub. No.: US 2024/0083429 A1
(43) Pub. Date: Mar. 14, 2024

(54) TRAVELING POSITION DETERMINATION DEVICE, TRAVELING POSITION DETERMINATION METHOD, NONTRANSITORY COMPUTER READABLE STORAGE MEDIUM STORING TRAVELING POSITION DETERMINATION PROGRAM, NON-TRANSITORY COMPUTER READABLE STORAGE MEDIUM STORING MAP DATA STRUCTURE

(71) Applicant: DENSO CORPORATION, Kariya-city (JP)

(72) Inventors: SHUN SHIMIZU, Kariya-city (JP); MINORU OKADA, Kariya-city (JP); HIROSHI INOU, Kariya-city (JP)

(21) Appl. No.: 18/518,250

(22) Filed: Nov. 22, 2023

Related U.S. Application Data
(63) Continuation of application No. PCT/JP2022/021386, filed on May 25, 2022.

(30) Foreign Application Priority Data
May 28, 2021 (JP) 2021-090408

(51) Int. Cl. B60W 30/12; B60W 30/16; B60W 40/06; B60W 50/00; B60W 60/00

(52) U.S. Cl. CPC B60W 30/12; B60W 30/16; B60W 40/06; B60W 50/0097; B60W 60/00256; B60W 2530/20; B60W 2552/53; B60W 2554/4041; B60W 2554/406; B60W 2554/80; B60W 2556/40

(57) ABSTRACT

By a traveling position determination device, a traveling position determination method, a non-transitory computer-readable storage medium storing a traveling position determination program, or by a non-transitory computer-readable storage medium storing a map data structure including a traveling position of a vehicle capable of performing automated driving, an offset of the traveling position in a lateral direction of the vehicle with respect to a reference position is determined.

### CROSS REFERENCE TO RELATED APPLICATIONS

The present application is a continuation application of International Patent Application No. PCT/JP2022/021386 filed on May 25, 2022, which designated the U.S. and claims the benefit of priority from Japanese Patent Application No. 2021-090408 filed on May 28, 2021. The entire disclosures of all of the above applications are incorporated herein by reference.

### TECHNICAL FIELD

The present disclosure relates to a traveling position of a vehicle capable of performing automated driving.

### BACKGROUND

In a technology of a comparative example, in order to prevent an occurrence of a rut, the amount of offset with respect to a center position of a lane of a road is set for each traveling vehicle. This technology estimates the lane center position based on detected lane markings, and calculates the amount of offset in a vehicle width direction with respect to a lane center position based on the estimated lane center position and vehicle width.

### SUMMARY

By a traveling position determination device, a traveling position determination method, a non-transitory computer-readable storage medium storing a traveling position determination program, or by a non-transitory computer-readable storage medium storing a map data structure including a traveling position of a vehicle capable of performing automated driving, an offset of the traveling position in a lateral direction of the vehicle with respect to a reference position is determined.

### BRIEF DESCRIPTION OF DRAWINGS

FIG. 1 is a diagram showing an automated driving control system.

FIG. 2 is a block diagram showing an example of functions of a vehicle.

FIG. 3 is a block diagram showing an example of functions of the server device.

FIG. 4 is a flowchart showing an example of a traveling position determination method executed by a server device.

FIG. 5 is a block diagram showing an example of functions of an automated driving ECU according to a second embodiment.

FIG. 6 is a flowchart showing an example of a traveling position determination method executed by the automated driving ECU according to the second embodiment.

FIG. 7 is a block diagram showing an example of functions of the automated driving ECU according to a third embodiment.

FIG. 8 is a flowchart showing an example of the traveling position determination method executed by the automated driving ECU according to the third embodiment.

### DETAILED DESCRIPTION

The comparative example does not show the detailed offset amount determination method. Therefore, according to the technology of the comparative example, a traveling position of the vehicle may not be appropriately determined.

One example of the present disclosure provides a traveling position determination device, a traveling position determination method, a non-transitory computer-readable storage medium storing a traveling position determination program, and a non-transitory computer-readable storage medium storing a map data structure capable of appropriately determining a traveling position of a vehicle.

According to one example embodiment, a traveling position determination device is configured to determine a traveling position of a vehicle capable of performing automated driving, and includes: a prediction unit configured to predict a deterioration status of a road surface and a tire of the vehicle when the vehicle travels in a lane in which the vehicle is scheduled to travel; and a traveling position determination unit configured to determine an offset in a lateral direction of the lane with respect to a reference position of the traveling position when the vehicle travels in the lane, based on the deterioration status.

According to another example embodiment, a traveling position determination method is executed by a processor for determining a traveling position of a vehicle capable of performing automated driving, and includes: predicting a deterioration status of a road surface and a tire of the vehicle when the vehicle travels in a lane in which the vehicle is scheduled to travel; and determining an offset in a lateral direction of the lane with respect to a reference position of the traveling position when the vehicle travels in the lane, based on the deterioration status.

Further, according to another example embodiment, a non-transitory computer-readable storage medium stores a traveling position determination program including instructions configured to, when executed by a processor for determining a traveling position of a vehicle capable of performing automated driving, cause the processor to: predict a deterioration status of a road surface and a tire of the vehicle when the vehicle travels in a lane in which the vehicle is scheduled to travel; and determine an offset in a lateral direction of the lane with respect to a reference position of the traveling position when the vehicle travels in the lane, based on the deterioration status.

Furthermore, according to another example embodiment, a non-transitory computer-readable storage medium stores a map data structure including a traveling position of a vehicle capable of performing automated driving, and the structure includes: lane information regarding a lane in which the vehicle is scheduled to travel; and a traveling position that is a target set for traveling of the vehicle in the lane. An offset of the traveling position in a lateral direction of the lane with respect to a reference position is determined based on a predicted deterioration status of a road surface and a tire of the vehicle when the vehicle travels in the lane.

According to the example embodiments, the offset of the traveling position in a lateral direction of the lane with respect to the reference position is determined based on the predicted deterioration status of a road surface and a tire of the vehicle when the vehicle travels in the lane. Therefore, it is possible to more easily prevent deterioration of at least one of the road surface or the tire of the vehicle traveling at the traveling position. Accordingly, it is possible to appropriately determine the traveling position of the vehicle.

Furthermore, according to another example embodiment, a traveling position determination device is configured to determine a traveling position of a vehicle capable of performing automated driving, and includes: an identification unit configured to identify an allowable area in which the vehicle is allowed to travel in a lane in the vehicle is scheduled to travel; and a traveling position determination unit configured to randomly determine an offset in a lateral direction of the lane with respect to a reference position of the traveling position within an allowable area when the vehicle travels in the lane, based on the deterioration status.

Furthermore, according to another example embodiment, a traveling position determination method determines a traveling position of a vehicle capable of performing automated driving, and includes: identifying an allowable area in which the vehicle is allowed to travel in a lane in the vehicle is scheduled to travel; and randomly determining an offset in a lateral direction of the lane with respect to a reference position of the traveling position within an allowable area when the vehicle travels in the lane.

Furthermore, according to another example embodiment, a non-transitory computer-readable storage medium stores a traveling position determination program including instructions configured to, when executed by a processor for determining a traveling position of a vehicle capable of performing automated driving, cause the processor to: identify an allowable area in which the vehicle is allowed to travel in a lane in the vehicle is scheduled to travel; and randomly determine an offset in a lateral direction of the lane with respect to a reference position of the traveling position within an allowable area when the vehicle travels in the lane.

Furthermore, according to another example embodiment, a non-transitory computer-readable storage medium stores a map data structure including a traveling position of a vehicle capable of performing automated driving, and the structure includes: lane information regarding a lane in which the vehicle is scheduled to travel; and a traveling position that is a target set for traveling of the vehicle in the lane. The traveling position is randomly determined by an offset in the lateral direction of the lane with respect to the reference position within an allowable area in which the vehicle is allowed to travel.

According to these example embodiments, the traveling position is randomly determined by an offset in the lateral direction of the lane with respect to the reference position within an allowable area in which the vehicle is allowed to travel. Therefore, it is possible to more easily prevent deterioration of at least one of the road surface or the tire of the vehicle traveling at the traveling position. Accordingly, it is possible appropriately determine the traveling position of the vehicle.

### First Embodiment

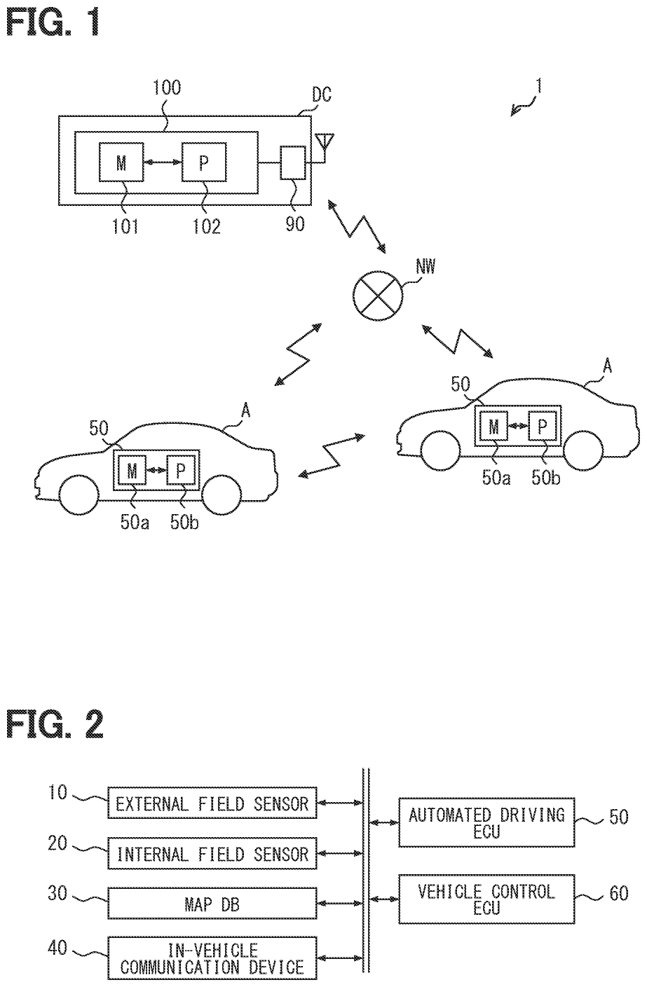

As shown in FIG. 1, a traveling position determination device according to an embodiment of the present disclosure is provided by a server device 100. The server device 100 is placed at a center DC, and constitutes an automated driving control system 1 of a vehicle A together with an automated driving ECU 50 mounted in the vehicle. The center DC and each of the vehicles A are configured to be able to wirelessly communicate with each other via a network NW.

The automated driving ECU 50 is an electronic control unit that performs at least one of an autonomous driving function or an advanced driving assist function. As shown in FIG. 2, the automated driving ECU 50 is connected to an external field sensor 10, an internal field sensor 20, a map database (hereinafter referred to as “map DB”) 30, an in-vehicle communication device 40, a vehicle control ECU 60 mounted on the vehicle, and a communication bus, and the like.

The external field sensor 10 is a sensor that acquires external field data of the vehicle A. The external field sensor 10 is a target sensing type that senses a target object existing in the external field to obtain the external field data. The target object sensing type external field sensor 10 is at least one type of, for example, radar, LiDAR, camera, sonar, or the like. The external field sensor 10 may include a GNSS receiver that receives a positioning signal from a GNSS (Global Navigation Satellite System) satellite existing in the external field of the vehicle A and acquires external field data.

The internal field sensor 20 is of a physical quantity sensing type that senses a specific motion physical quantity in the internal field of the vehicle A to obtain internal field data. This type of internal field sensor is, for example, at least one of a traveling speed sensor, an acceleration sensor, a gyro sensor, or the like. The internal field sensor 20 may include an occupant sensing type that senses a specific state or specific operation of the occupant in the internal field of the vehicle A to obtain internal field data. This type of internal field sensor 20 is at least one of, for example, a starting sensor, a door lock sensor, a door opening-closing sensor, a steering sensor, an accelerator sensor, a brake sensor, a direction indicator sensor, a seating sensor, a driver status monitor, or an in-vehicle equipment sensor.

The map DB 30 is a nonvolatile memory and stores map data such as link data, node data, road shapes, buildings and the like. The map data may include a three-dimensional map including feature points of road shapes and buildings. Note that the three-dimensional map may be generated based on an image captured by REM (registered trademark). Further, the map data may include traffic regulation information, road construction information, meteorological information, signal information and the like. The map data stored in the map DB 30 may be updated periodically or as needed based on the latest information delivered from a server installed outside the vehicle A.

The in-vehicle communication device 40 is a communication module mounted on the vehicle A. The in-vehicle communication device 40 has at least the function of V2N (Vehicle to cellular Network) communication in accordance with communication standards such as LTE (Long Term Evolution) and 5G, and can receive correction information used in RTK positioning from a reference station around the vehicle A. The in-vehicle communication device 40 sequentially provides the acquired correction information to the server device 100.

The automated driving ECU 50 is an electronic control unit that performs at least one of an autonomous driving function or an advanced driving assist function. The automated driving ECU 50 is a computer including at least one memory 50a and at least one processor 50b. The memory 50a is at least one type of computer-readable non-transitory tangible storage medium, such as, for example, a semiconductor memory, a magnetic medium, an optical medium, for non-transitory storage of computer readable programs and data. The memory 50a stores various programs executed by the processor 50b. The processor 50b implements various functions by executing a plurality of instructions included in a program. For example, the automated driving ECU 50 generates a traveling route for the vehicle A based on information from the external field sensor 10, the internal field sensor 20, the map DB 30, the in-vehicle communication device 40, and the like. The automated driving ECU 50 outputs a command to the vehicle control ECU 60 to perform driving assistance or autonomous driving along the traveling route.

The vehicle control ECU 60 is an electronic control unit that performs acceleration and deceleration control and steering control of the vehicle A. The vehicle control ECU 60 includes an accelerator ECU that performs acceleration control, a brake ECU that performs deceleration control, a steering ECU that performs steering control, and the like. The vehicle control ECU 60 acquires detection signals output from respective sensors such as the steering angle sensor, the vehicle speed sensor, and the like mounted in the vehicle A, and outputs a control signal to an electronic control throttle, a brake actuator, an EPS (i.e., Electronic Power Steering) motor, and the like. The vehicle control ECU 60 acquires the traveling route of the vehicle A during autonomous driving from the automated driving ECU 50, and controls each traveling control device so as to implement driving assistance or autonomous traveling according to the travel route.

The center DC includes a communication device 90 and a server device 100. The communication device 90 is a communication device electrically connected to the server device 100, and enables communication between the center DC and vehicle A via a network NW.

The server device 100 is provided by a computer including at least one memory 101 and at least one processor 102. The memory 101 is at least one type of computer-readable non-transitory tangible storage medium, such as, for example, a semiconductor memory, a magnetic medium, an optical medium, for non-transitory storage of computer readable programs and data. The memory 101 stores various programs executed by the processor 102, such as a traveling position determination program described later.

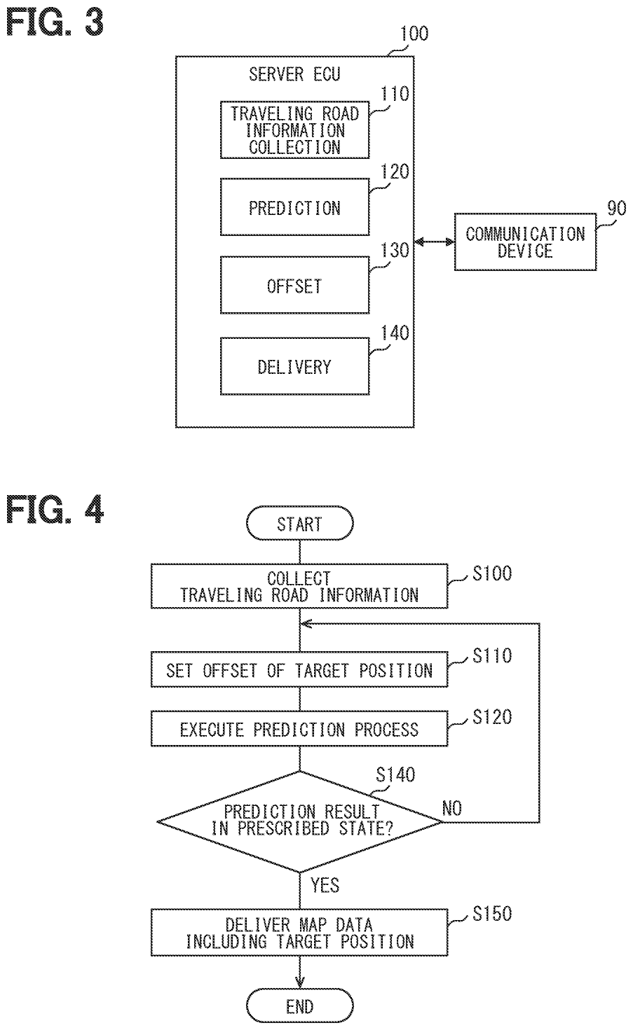

The processor 102 includes, for example, at least one of a central processing unit (CPU), a graphics processing unit (GPU), a reduced instruction set computer (RISC)-CPU, and the like as a core. The processor 102 executes multiple instructions included in a positioning program stored in the memory 101. Thereby, the server device 100 constructs a plurality of functional units for estimating the current position of the vehicle A. As described above, in the server device 100, the traveling control program stored in the memory 101 causes the processor 102 to execute the multiple instructions, thereby constitutes functional units. Specifically, as shown in FIG. 3, the server device 100 includes functional units such as a traveling road information collection unit 110, a prediction unit 120, an offset determination unit 130, and a delivery unit 140.

The traveling road information collection unit 110 collects information on a defined traveling road (traveling road information). For example, the traveling road information collection unit 110 may collect traveling road information in a preset area. The traveling road information collection unit 110 collects information to be input into a deterioration model, which will be described later, or related information thereof, as the traveling road information. For example, the traveling road information may be an image of the traveling road, or may be a parameter indicating a deterioration state of the traveling road estimated based on detection information such as an image. Note that the deterioration state of the traveling road includes, for example, the depth of ruts, the presence or absence of cracks in the asphalt, and the like. Note that as track information, the elapsed time since the traveling road maintenance, temperature changes in the area where the traveling road exists, or the like may be collected. The traveling road information collection unit 110 may accumulate and collect traveling road information for a specific period. The specific period is, for example, a period from a predetermined timing to the day before map generation. Alternatively, the traveling road information collection unit 110 may collect data collected by a specific vehicle A, such as the last traveling vehicle of the previous day, as the traveling road information.

The prediction unit 120 executes a prediction process for determining target positions of the plurality of vehicles A in a lateral direction of the lane in which they are scheduled to travel. The target position here is the position of a node that defines the traveling route of vehicle A in time series. Further, the lateral direction here is a direction perpendicular to a direction in which the lane extends. The target position is an example of a “traveling position.” For example, the prediction unit 120 executes two prediction processes: deterioration prediction for the traveling road of each lane and deterioration prediction of tires of the vehicle A traveling on each lane.

In predicting road surface deterioration, the prediction unit 120 may predict the deterioration state based on a traveling road deterioration model that outputs a distribution sum (deterioration distribution sum) of traveling road deterioration degrees with respect to input information. The input information includes, for example, traveling road information, a traveling distribution with a temporarily set offset (described later), the weight of the vehicle A, and the like.

In predicting tire deterioration, the prediction unit 120 may predict the deterioration state based on a tire deterioration model that outputs a parameter indicating the degree of tire deterioration in response to input information. The input information includes, for example, traveling road information, a traveling distribution with a temporarily set offset (described later), the weight of the vehicle A, friction coefficient of the tires and the like.

The offset determination unit 130 determines a lateral offset of the target position of the vehicle A with respect to a reference position (for example, the center of the lane). For example, the offset determination unit 130 calculates the error distribution (traveling distribution) of the traveling position of each vehicle A traveling on the traveling road. Then, the offset determination unit 130 temporarily sets an offset for the traveling distribution of the plurality of vehicles A scheduled to travel on the traveling road. The offset determination unit 130 performs offset adjustment for each target position based on the traveling road and tire deterioration prediction results. The offset determination unit 130 adjusts the offset so that the sum of the distributions of the traveling road deterioration degree is in a prescribed state, and the degree of tire deterioration progress in each vehicle A is in a prescribed state.

Regarding the degree of traveling road deterioration, the offset determination unit 130 may determine that the sum of deterioration distributions is in a prescribed state, for example, when the area difference from a predetermined ideal deterioration distribution sum and the area outside the ideal deterioration distribution sum are small enough to fall within an allowable range.

Regarding the degree of tire deterioration progress, the offset determination unit 130 may determine that the prescribed state has been reached, for example, when the degree of tire deterioration progress is compatible with a tire replacement schedule of each vehicle A. As an example, when the timing at which each vehicle A reaches a degree of deterioration that requires the tire replacement is less than or equal to a predetermined number within a predetermined period, the offset determination unit 130 determines that the degree of deterioration has reached a degree of deterioration progress that is compatible with the replacement schedule.

Note that, when the vehicle A has an operational schedule, the offset determination unit 130 may perform offset adjustment according to the operational schedule. For example, the offset determination unit 130 may adjust the offset so that the degree of deterioration that requires the tire replacement is reached during a period when the vehicle A is not in operation.

The offset determination unit 130 may adjust the offset again based on the output traveling road deterioration distribution sum and tire deterioration progress degree, and repeat the process of outputting each prediction result again to set each prediction result in the prescribed state. When the offset adjustment is completed, the offset determination unit 130 provides, to the delivery unit 140, information regarding the target position to which the offset has been set. The offset determination unit 130 is an example of a “traveling position determination unit”.

The delivery unit 140 distributes information including the offset-set target position to the vehicle A. Specifically, the delivery unit 140 distributes distribution data including lane information regarding the lane in which the vehicle is scheduled to travel and the traveling position in which the offset has been set. The lane information may be, for example, link data and node data of the lane, or may be point group data regarding the road surface of the lane, lane markings, and the like. Alternatively, the lane information may be linking information that associates the coordinates of the traveling position with a corresponding lane. The above distribution data structure is an example of a “map data structure.”

Next, the flow of a traveling control method executed by the server device 100 through collaboration of functional blocks will be described below with reference to FIG. 4. In the flow to be described later, “S” indicates one or more processes of the flowchart to be executed by one or more instructions included in the program.

First, in S100, the traveling road information collection unit 110 collects traveling road information. Next, in S110, the offset determination unit 130 sets an offset for the target position. Next, in S120, the prediction unit 120 executes the prediction process. In subsequent S140, the offset determination unit 130 determines whether the prediction result is in the prescribed state. When it is determined that the prediction result is not in the prescribed state, the flow returns to S110, and the offset is reset. On the other hand, when it is determined that the sum of deterioration distributions is in the prescribed state, the flow proceeds to S150. In S150, the delivery unit 140 transmits map data including the offset-set target position to the vehicle A. In the above, S120 corresponds to a “prediction process,” S110 and S140 correspond to a “traveling position determination process,” and S150 corresponds to a “delivery process.”

According to the first embodiment described above, the traveling position is randomly determined by an offset in the lateral direction of the lane with respect to the reference position within an allowable area in which the vehicle is allowed to travel. Therefore, it is possible to more easily prevent deterioration of at least one of the road surface or the tires of the vehicle traveling at the traveling position. Accordingly, it is possible to appropriately determine the traveling position of the vehicle.

### Second Embodiment

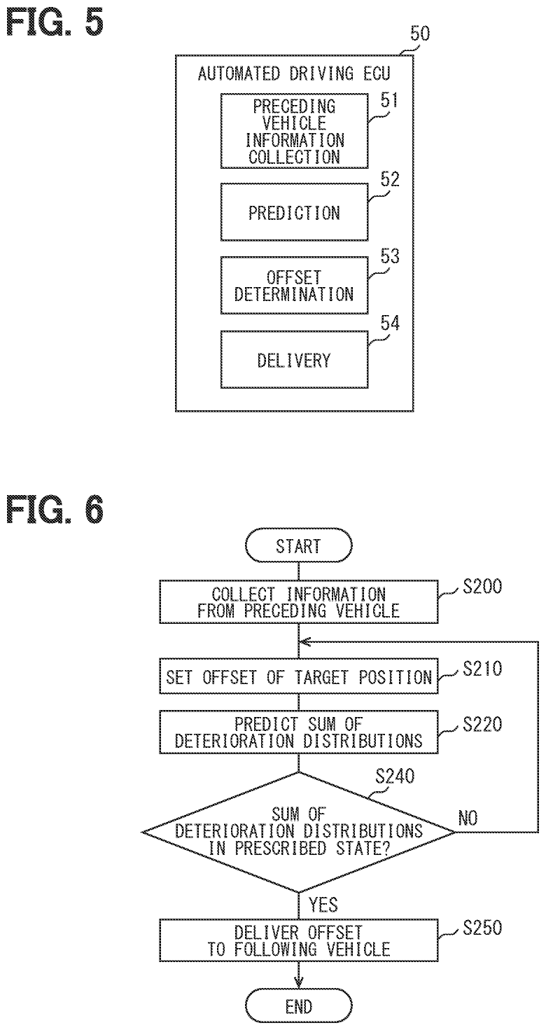

In a second embodiment, a modification of the traveling control device in the first embodiment will be described. In FIG. 5 and FIG. 6, the components denoted by the same reference symbols as those in the drawings of the first embodiment are equivalent to the components in the first embodiment, and provide similar operational effects.

In the second embodiment, the traveling control device is provided by the automated driving ECU 50 mounted on the vehicle A. The automated driving ECU 50 includes a preceding vehicle information collection unit 51, a prediction unit 52, an offset determination unit 53, and a delivery unit 54. Note that in the following, for the purpose of describing the functional parts, the vehicle A will be referred to as a “subject vehicle”, the vehicle preceding the subject vehicle will be referred to as a “preceding vehicle”, and a vehicle following the subject vehicle will be referred to as a “following vehicle”.

The preceding vehicle information collection unit 51 collects information necessary for determining the target position from the preceding vehicle. Specifically, the preceding vehicle information collection unit 51 acquires the traveling distribution including offset information of the vehicle A to the preceding vehicle. The preceding vehicle information collection unit 51 may acquire traveling route information obtained by the preceding vehicle or the vehicle A traveling in front of the preceding vehicle.

The prediction unit 52 executes a prediction process similarly to the prediction unit 120 in the first embodiment. The prediction unit 52 may execute the prediction process based on the information collected by the preceding vehicle information collection unit 51.

The offset determination unit 53 determines the offset of the target position of the subject vehicle. For example, the offset determination unit 53 may readjust the offset in the subject vehicle so that the sum of the deterioration distributions across the plurality of vehicles A becomes the prescribed state. The offset determination unit 53 is an example of the “traveling position determination unit”.

The delivery unit 54 delivers the offset information of the target position of the subject vehicle to the following vehicle (also referred to as a rear vehicle) together with the offset information of the preceding vehicle and a plurality of vehicles ahead of the preceding vehicle. When there is the traveling information collected by the subject vehicle, the delivery unit 54 may deliver the information to the following vehicle.

Next, the flow of the traveling position determination method executed by the automated driving ECU 50 of the second embodiment through collaboration of functional blocks will be described below with reference to FIG. 6.

First, in S200, the preceding vehicle information collection unit 51 collects information on the preceding vehicle. Next, in S210, the offset determination unit 53 sets an offset for the target position. Next, in S220, the prediction unit 52 predicts the deterioration status of the road surface and tires. In subsequent S240, the offset determination unit 53 determines whether the predicted sum of road surface deterioration distribution is in the prescribed state. When it is determined that the prediction result is not in the prescribed state, the flow returns to S210, and the offset is reset. On the other hand, when it is determined that the sum of deterioration distributions is in the prescribed state, the flow proceeds to S250. In S250, the delivery unit 54 deliveries the offset-set target position to the current vehicle to the following vehicle. In the above, S220 corresponds to the “prediction process,” S210 and S240 correspond to the “traveling position determination process,” and S250 corresponds to the “delivery process.”

### Third Embodiment

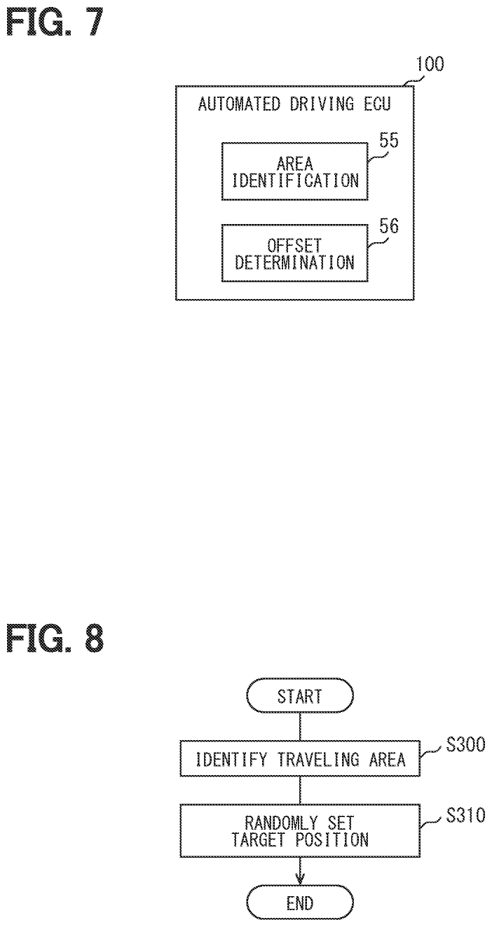

In a third embodiment, a modification to the server device 100 in the first embodiment will be described. In FIG. 7 and FIG. 8, the components denoted by the same reference symbols as those in the drawings of the first embodiment are equivalent to the components in the first embodiment, and provide similar operational effects.

In the third embodiment, the traveling position determination device is provided by the automated driving ECU 50. The automated driving ECU 50 stores a traveling position determination program in the memory 50a. The processor 50b constructs a plurality of functional units by executing a plurality of instructions included in the traveling position determination program. Specifically, the processor 50b constructs an area identification unit 55 and an offset determination unit 56 as functional units. The area identification unit 55 identifies a traveling area in the lane in which the vehicle can be scheduled to travel. For example, the area identification unit 55 may identify the traveling area based on position information of left and right lane markings and vehicle width information stored in the memory 50a or the like. The area identification unit 55 is an example of an “identification unit”.

The offset determination unit 56 determines the offset of the target position. The offset determination unit 56 randomly determines a target position within the traveling area. The offset determination unit 56 may determine the target position based on the Monte Carlo method or the like. The offset determination unit 56 is an example of the “traveling position determination unit”.

Next, the flow of the positioning method executed by the automated driving ECU 50 of the third embodiment through collaboration of functional blocks will be described below with reference to FIG. 8.

First, in S300, the area identification unit 55 identifies the traveling area in the lane in which the vehicle is scheduled to travel. Next, in S310, the offset determination unit 56 randomly sets the offset of the target position. In the above, S300 corresponds to an “identification process” and S310 corresponds to a “traveling position determination process”.

Note that the automated driving ECU 50 may be configured to randomly set the offset when map data including the target position from the server device 100 or offset information from the preceding vehicle cannot be obtained. In this case, the automated driving ECU 50 may set the allowable offset range to be smaller than the offset setting performed by the server device 100 or the offset setting performed based on the preceding vehicle information.

### Other Embodiments

The present disclosure is not limited to the above-described embodiments. The present disclosure includes embodiments described above and modifications of the above-described embodiments made by a person skilled in the art. For example, the disclosure is not limited to components and/or combinations of elements presented in the embodiments provided herein. The present disclosure may be implemented in various combinations thereof. The disclosure may have additional components that can be added to the embodiments. The present disclosure also includes modifications which include partial components/elements of the above-described embodiments. The present disclosure includes replacements of components and/or elements between one embodiment and another embodiment, or combinations of components and/or elements between one embodiment and another embodiment The disclosed technical scope is not limited to the description of the embodiment. Several technical scopes disclosed are indicated by descriptions in the claims and should be understood to include all modifications within the meaning and scope equivalent to the descriptions in the claims.

As a modification of the above-described embodiments, the server device 100 or the automated driving ECU 50 may transmit a repair notification for the road surface to a terminal of a service provider when the degree of road surface deterioration has progressed to a predetermined value or more.

In the embodiments described above, the dedicated computer configuring the traveling control device is the server device 100 or the automated driving ECU 50. Alternatively, the dedicated computer that constitutes the traveling control device may be the driving control ECU mounted on the vehicle A, or may be an actuator ECU that individually controls the traveling actuators of the vehicle A. Alternatively, the dedicated computer that constitutes the traveling control device may be a navigation ECU. The dedicated computer included in the positioning device may be an HCU (i.e., HMI (i.e., Human Machine Interface) Control Unit) that controls information presentation of the information presentation system.

The server device 100 may be a special purpose computer configured to include at least one of a digital circuit and an analog circuit as a processor. In particular, the digital circuit is at least one type of, for example, an ASIC (Application Specific Integrated Circuit), a FPGA (Field Programmable Gate Array), an SOC (System on a Chip), a PGA (Programmable Gate Array), a CPLD (Complex Programmable Logic Device), and the like. Such a digital circuit may include a memory in which a program is stored.

The server device 100 may be a set of computer resources linked by a computer or data communication device. For example, some of the functions provided by the server device 100 in the above-described embodiments may be implemented by another ECU or a server device.

1. A traveling position determination device configured to determine a traveling position of a vehicle capable of performing automated driving, the device comprising:
a prediction unit configured to predict a deterioration status of a road surface and a tire of the vehicle when the vehicle travels in a lane in which the vehicle is scheduled to travel; and
a traveling position determination unit configured to determine an offset in a lateral direction of the lane with respect to a reference position of the traveling position when the vehicle travels in the lane, based on the deterioration status.

2. The traveling position determination device according to claim 1, wherein
the vehicle includes a plurality of vehicles, and
the traveling position determination device further includes a delivery unit configured to deliver a traveling route of at least one vehicle among the plurality of vehicles to the plurality of vehicles, the traveling route including the traveling position.

3. The traveling position determination device according to claim 1, wherein
the vehicle includes a plurality of vehicles,
the plurality of vehicles include a specific vehicle, a preceding vehicle preceding the specific vehicle, and a rear vehicle positioned in rear of the specific vehicle,
the traveling position determination unit is configured to determine an offset of the traveling position of the specific vehicle with respect to the preceding vehicle, and
the traveling position determination device further includes a delivery unit configured to deliver the traveling position to the rear vehicle.

4. A traveling position determination device that is mounted on a vehicle capable of performing automated driving and configured to determine a traveling position of the vehicle, the device comprising:
an identification unit configured to identify an allowable area in which the vehicle is allowed to travel in a lane in the vehicle is scheduled to travel; and
a traveling position determination unit configured to randomly determine an offset in a lateral direction of the lane with respect to a reference position within the allowable area, when the traveling position in the lane is not acquirable from a server device outside the vehicle or a preceding vehicle preceding the vehicle.

5. A non-transitory computer-readable storage medium storing a map data structure including a traveling position of a vehicle capable of performing automated driving, the structure comprising:
lane information regarding a lane in which the vehicle is scheduled to travel; and
a traveling position that is a target set for traveling of the vehicle in the lane,
wherein
an offset of the traveling position in a lateral direction of the lane with respect to a reference position is determined based on a predicted deterioration status of a road surface and a tire of the vehicle when the vehicle travels in the lane.

6. A non-transitory computer-readable storage medium storing a map data structure including a traveling position of a vehicle capable of performing automated driving, the structure comprising:
lane information regarding a lane in which the vehicle is scheduled to travel; and
a traveling position that is a target set for traveling of the vehicle in the lane,
wherein
an offset of the traveling position in a lateral direction of the vehicle with respect to a reference position is randomly determined within an allowable area in which the vehicle is allowed to travel when the traveling position is not acquirable from a server device outside the vehicle or a preceding vehicle preceding the vehicle.

7. The traveling position determination device according to claim 1, further comprising:
a processor;
a memory coupled to the processor and storing program instructions that when executed by the processor cause the processor to serve as the prediction unit and the traveling position determination unit.

8. The traveling position determination device according to claim 2, further comprising:
a processor;
a memory coupled to the processor and storing program instructions that when executed by the processor cause the processor to serve as the prediction unit, the traveling position determination unit, and the delivery unit.

9. The traveling position determination device according to claim 3, further comprising:
a processor;
a memory coupled to the processor and storing program instructions that when executed by the processor cause the processor to serve as the prediction unit, the traveling position determination unit, and the delivery unit.

10. The traveling position determination device according to claim 4, further comprising:
a processor;
a memory coupled to the processor and storing program instructions that when executed by the processor cause the processor to serve as the identification unit and the traveling position determination unit.
